(19) United States
(12) Patent Application Publication
(10) Pub. No.: US 2004/0218770 A1
(43) Pub. Date: Nov. 4, 2004

(54) Audio device with retractable earpieces

(76) Inventor: Eddie Chang, Hong Kong (HK)

Correspondence Address: Mr Guy D Yale, Alix, Yale & Ristas, LLP, 750 Main Street, Hartford, CT, 06103-2721, US

(21) Appl. No.: 10/820,359

(22) Filed: Apr. 8, 2004

(30) Foreign Application Priority Data
Apr. 11, 2003 (GB) 0308414.2

(51) Int. Cl. H04R 5/02

(52) U.S. Cl. 381/309

(57) ABSTRACT

An audio device comprising a casing containing a circuit and a spool rotatable about an axis, two earpieces connected by lead wires,

the lead wires being wound onto the spool so that the earpieces are deployed or retracted as the spool rotates,

the spool including two or three concentric circular tracks each track being connected to a respective lead wire,

a contact within the casing being each arranged to engage a respective track as the spool rotates to connect the earpieces to the circuit.

This invention relates to an audio device, particularly if not exclusively to a portable audio device including a pair of earphones or earpieces connected to a body by spoolable lead wires, so that the wires may be retracted onto a spool contained within the body of the device.

In previous devices the circuit components have been located on the spool to rotate with the spool as the earplugs are deployed or retracted. This facilitates connection of the circuit to the lead wires but results in a bulky spool assembly. An alternative arrangement wherein the lead wires extend from the rotatable spool to a fixed circuit gives rise to a risk of fracture of the wires due to twisting as the spool rotates.

According to the present invention an audio device comprises a casing containing a circuit and a spool rotatable about an axis, and two earpieces connected by lead wires,

the lead wires being wound onto the spool so that the earpieces are deployed or retracted as the spool rotates,

the spool including a plurality of concentric circular tracks each track being connected to a respective lead wire,

a contact within the casing being each arranged to engage a respective track as the spool rotates to connect the earpieces to the circuit.

The device may comprise a radio tuner, MP3 player or disc or cassette player in which the spool is disposed within the body housing the electronic and other components. In a preferred embodiment the device comprises an FM scan radio. Alternatively, the spool may be located in a casing separate from the main body together with a receiver, adapted to receive a signal generated by the primary circuitry in the main body.

Two tracks may be used for a monophonic device. Three tracks may be used for a stereophonic device.

In a first preferred embodiment two tracks are located at inner and outer radii having an annular space between the tracks.

In a second preferred embodiment three tracks are located at inner, intermediate and outer radii having annular spaces between the inner and intermediate tracks and between the intermediate and outer tracks.

The spool preferably comprises an axial spindle and a radially extending end plate carrying the circular tracks.

The contacts are preferably biassed towards the tracks and may comprise resilient metal leaves or other members. Alternatively, the contacts may comprise brushes or pads urged towards the tracks by spring means.

In preferred embodiments the contacts engage the plate carrying the circular tracks on a diameter thereof at different radii.

In preferred embodiments the spool includes a spring to retract the earpieces from an extended position to a stowed position.

The spool may comprise a rotatable drum to receive the wires and a fixed base plate.

The invention is further described by means of example but not in any limitative sense with reference to the accompanying drawings of which:

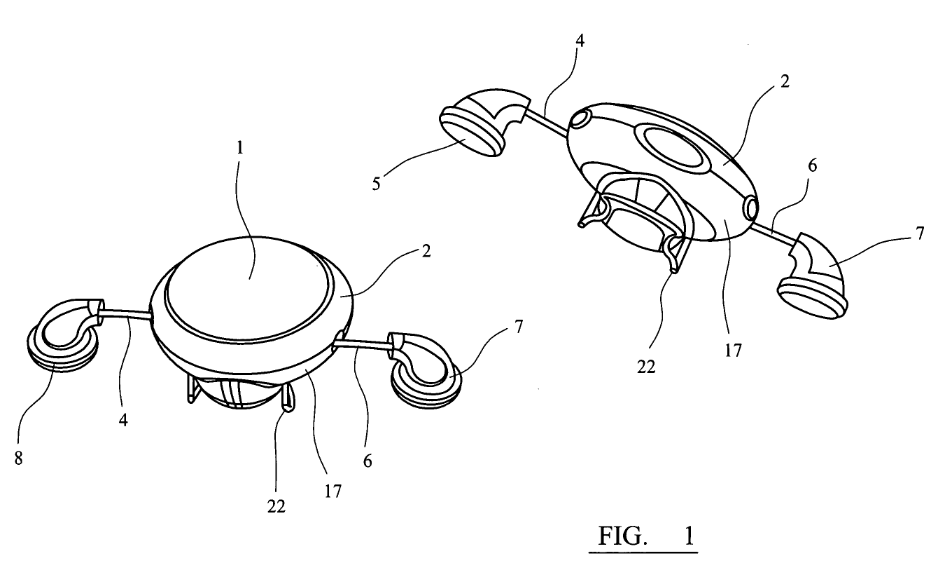

FIG. 1 is two perspective views of an audio device in accordance with the invention;

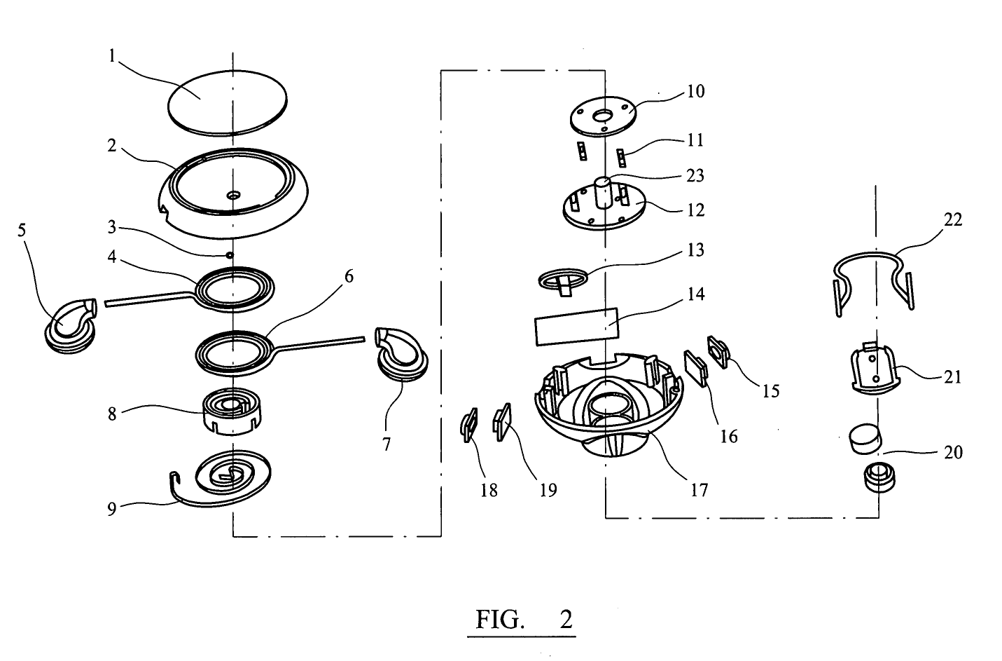

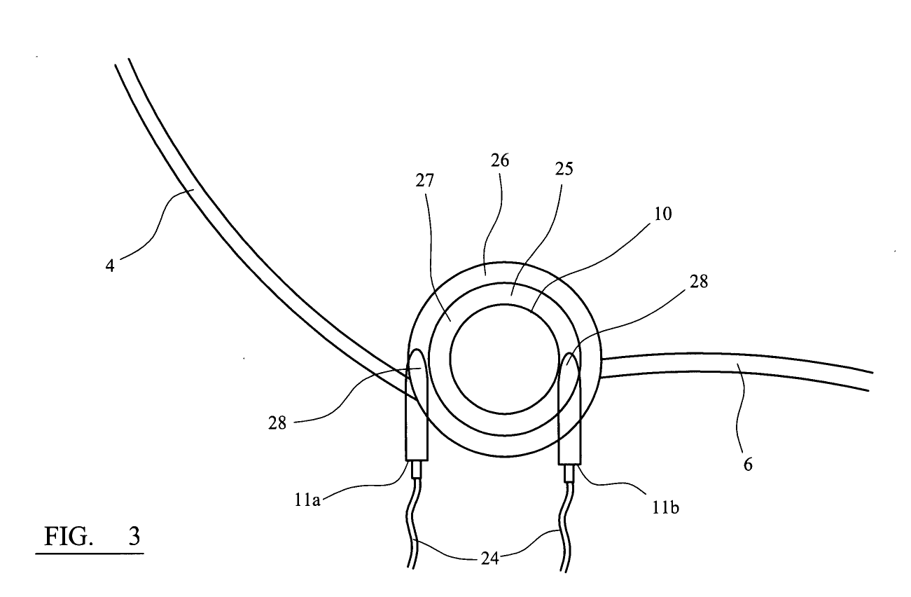

FIG. 2 is an exploded view of the device shown in FIG. 1;

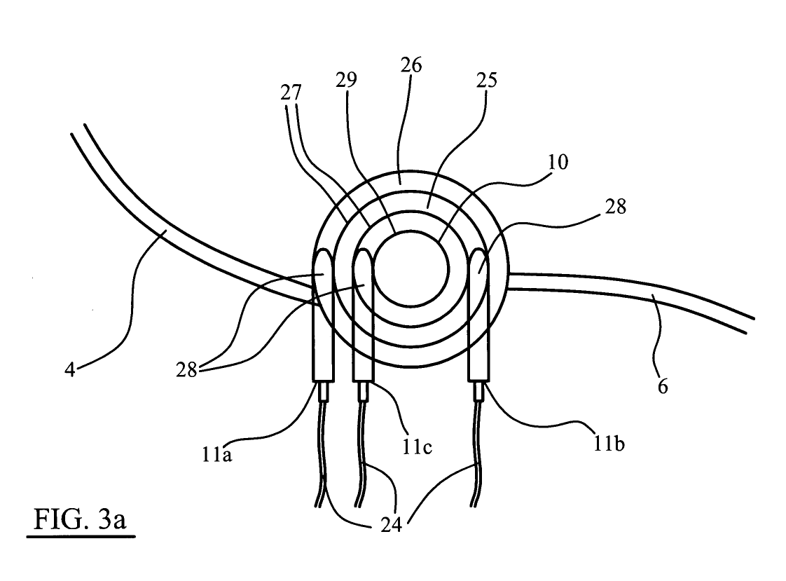

FIG. 3 illustrate the tracks and contacts shown in FIG. 1; and

FIG. 3a illustrates an alternative stereophonic arrangement.

FIG. 1 shows two perspective views of an FM scan radio in accordance with the present invention. The casing consists of an upper shell 2 and a lower shell 17. The upper shell 2 includes a transparent cover lens 1 to display an information sheet or publicity material.

Earpieces 5, 7 are mounted on the ends of lead wires 4, 6 and may be drawn away from the casing against the restoring force of a spring. A clip 22 allows the device to be attached to a user's clothing.

FIG. 2 is an exploded view of the assembled components. The lower casing 17 contains an integrated circuit board 14 carrying the components of the tuner or other electronic circuit. The batteries 20 are retained by a cover 21 in a compartment in the casing 17. Control buttons 15, 18 and slide knob 13 actuate the tuner.

A circular plate 12 having an axial spindle 23 includes two slots which receive copper contact strips 11 by wires 24. The contact strips take the form of resilient leaves or plates which are electrically connected to the circuit 14. A circular plate 10 having an axial bore to receive the spindle 23 of plate 12 has two concentric annular conductive tracks 25, 26 at different radii on the surface. The contacts 11 are at the same radii from the axis of plate 12 so that each contact 11 engages and makes permanent electric contact with the respective circular contact track 25, 26 on plate 10.

A spool 8 mounted on the spindle 23 engages one end of spiral spring 9, the other end of the spring being secured to casing 17. Earpieces 5, 7 are connected to the plate 10 by lead wires 4, 6 wound around the spool 8.

When a user pulls the earpieces 5, 7 from the casing rotation of the spool tightens the spring 9. This provides a restoring force to retract the earpieces when they are released. The lead wires 4, 6 are both stowed on spool 8, providing a compact and reliable arrangement.

FIG. 3 illustrates the contact arrangement for a monophonic device in greater detail. FIG. 3 shows the underside of the circular plate 10 having two concentric contact tracks 25, 26 on the surface with an insulating space 27 between them. Contact 11a and 11b, formed from resilient copper leaves are formed so that their ends 28 contact the tracks at different radii on a diameter of the plate 10. A constant electrical contact between the wires 24 and earpiece leads 4, 6 is maintained at all positions during rotation of the plate 10 and tracks 25, 26. The contacts 11 may be S shaped or otherwise deformed towards the tracks 25, 26 so that only the ends 28 contact the tracks.

FIG. 3a illustrates alternative arrangement for a stereo type device, FIG. 3a shows the underside of the circular plate 10 having three concentric contact tracks 25, 26 and 29 on the surface with annular insulating spaces 27 between them. Contact 11a, 11b and 11c, formed from resilient copper leaves are arranged so that their ends 28 contact the tracks at different radii on a diameter of the plate 10. A constant electrical contact between the wires 24 and earpiece leads 4, 6 is maintained at all positions during rotation of the plate 10 and tracks 25, 26 and 29. The contacts 11 may be S shaped or otherwise deformed towards the tracks 25, 26 and 29 so that only the ends 28 contact the tracks.

1. An audio device comprising a casing containing a circuit and a spool rotatable about an axis, two earpieces connected by lead wires,
the lead wires being wound onto the spool so that the earpieces are deployed or retracted as the spool rotates,
the spool including a plurality of concentric circular tracks each track being connected to a respective lead wire,
a contact within the casing being each arranged to engage a respective track as the spool rotates to connect the earpieces to the circuit.

2. An audio device as claimed in claim 1 wherein two tracks are located at inner and outer radii having an annular space between the tracks.

3. An audio device as claimed in claim 1, wherein three tracks are located at inner, intermediate and outer, radii having annular spaces between adjoined tracks.

4. An audio device as claimed in claim 1 wherein the spool comprises an axial spindle and a radially extending end plate carrying the circular tracks.

5. An audio device as claimed in claim 1 wherein the contacts are biassed towards the tracks.

6. An audio device as claimed in claim 1 wherein the contacts engage the tracks on a diameter thereof at different radii.

7. An audio device as claimed in claim 1 wherein the spool comprises a rotatable drum receiving the wires and a fixed base plate.

8. An audio device as claimed in claim 1 wherein the spool includes a spring to retract the earpieces from an extended position to a stowed position.

9. An audio device as claimed in claim 2 wherein the spool comprises an axial spindle and a radially extending end plate carrying the circular tracks.

10. An audio device as claimed in claim 2 wherein the spool comprises an axial spindle and a radially extending end plate carrying the circular tracks.

11. An audio device as claimed in claim 2 wherein the contacts are biassed towards the tracks.

12. An audio device as claimed in claim 3 wherein the contacts are biassed towards the tracks.

13. An audio device as claimed in claim 4 wherein the contacts are biassed towards the tracks.

14. An audio device as claimed in claim 2 wherein the contacts engage the tracks on a diameter thereof at different radii.

15. An audio device as claimed claim 3 wherein the contacts engage the tracks on a diameter thereof at different radii.

16. An audio device as claimed in claim 2 wherein the spool comprises a rotatable drum receiving the wires and a fixed base plate.

17. An audio device as claimed in claim 3 wherein the spool comprises a rotatable drum receiving the wires and a fixed base plate.

18. An audio device as claimed in claim 4 wherein the spool comprises a rotatable drum receiving the wires and a fixed base plate.

19. An audio device as claimed in claim 2 wherein the spool includes a spring to retract the earpieces from an extended position to a stowed position.

20. An audio device as claimed in claim 3 wherein the spool includes a spring to retract the earpieces from an extended position to a stowed position.
